(19) United States
(12) Patent Application Publication
(10) Pub. No.: US 2012/0300020 A1
(43) Pub. Date: Nov. 29, 2012

(54) REAL-TIME SELF-LOCALIZATION FROM PANORAMIC IMAGES

(75) Inventors: Clemens Arth, Judendorf-Strassengel (AT); Manfred Klopschitz, Graz (AT); Gerhard Reitmayr, Graz (AT); Dieter Schmalstieg, Graz (AT)

(73) Assignee: QUALCOMM Incorporated, San Diego, CA (US)

(21) Appl. No.: 13/417,976

(22) Filed: Mar. 12, 2012

Related U.S. Application Data
(60) Provisional application No. 61/490,792, filed on May 27, 2011.

(51) Int. Cl. H04N 7/00

(52) U.S. Cl. 348/36; 348/E07.001

(57) ABSTRACT

Real-time localization is performed using at least a portion of a panoramic image captured by a camera on a mobile device. A panoramic cylindrical map is generated using images captured by the camera, e.g., as the camera rotates. Extracted features from the panoramic cylindrical map are compared to features from a pre-generated three-dimensional model of the environment. The resulting set of corresponding features may be used to determine the pose of the camera. For example, the set of corresponding features may be converted into rays between the panoramic cylindrical map and the three-dimensional model, where the intersection of the rays is used to determine the pose. The relative orientation of the camera may also be tracked by comparing features from each new image to the panoramic cylindrical map, and the tracked orientation may be fused with the pose.

### CROSS-REFERENCE TO RELATED APPLICATION(S)

This application claims priority under 35 USC 119 to provisional application No. 61/490,792, filed May 27, 2011, entitled “Real-Time Self-Localization from Panoramic Images,” which is assigned to the assignee hereof and which is incorporated herein by reference.

### BACKGROUND

1. Background Field

Embodiments of the subject matter described herein are related generally to position and tracking, and more particularly to vision based tracking of mobile devices.

2. Relevant Background

Highly accurate 6-degree-of-freedom (DOF) self-localization with respect to the user's environment is an inevitable necessity for visually pleasing results in Augmented Reality. An efficient way to perform self-localization is to use sparse 3D point cloud reconstructions of the environment and to perform feature matching between the camera live image and the reconstruction. From the feature matches, the pose can be recovered by using a robust pose estimation scheme. Especially in outdoor environments, there are a lot of challenges, such as ever changing lighting conditions; huge amounts of data (point cloud) to be stored and managed; small amounts of memory and computational resources on mobile devices; inability to control the camera acquisition parameters; and a narrow field of view. Additionally, the field of view (FOV) of cameras in mobile devices, such as mobile phones, is typically very narrow, which has been shown to be a major issue for localization, particularly in expansive or outdoor environments.

### SUMMARY

Real-time localization is performed using at least a portion of a panoramic image captured by a camera on a mobile device. A panoramic cylindrical map is generated using images captured by the camera, e.g., as the camera rotates. Features are extracted from the panoramic cylindrical map and compared to features from a pre-generated three-dimensional model of the environment. The resulting set of corresponding features can then be used to determine a position and an orientation of the camera. For example, the set of corresponding features may be converted into a plurality of rays between the panoramic cylindrical map and the three-dimensional model, where the intersection of the rays is used to determine the position and orientation. The relative orientation of the camera may also be tracked by comparing features from each new image to the panoramic cylindrical map, and the tracked orientation may be fused with the position and orientation determined using the set of corresponding features. Further, portions of the three-dimensional model may be downloaded based on a coarse position of the camera.

In an embodiment, a method includes producing at least a portion of a panoramic cylindrical map of an environment with a camera; extracting features from the at least the portion of the panoramic cylindrical map; comparing the features from the at least the portion of the panoramic cylindrical map to features from a pre-generated three-dimensional model of the environment to produce a set of corresponding features; and using the set of corresponding features to determine a position and an orientation of the camera.

In an embodiment, an apparatus includes a camera capable of capturing images of an environment; and a processor coupled to the camera, the processor configured to produce at least a portion of a panoramic cylindrical map of the environment using images captured by the camera, extract features from the at least the portion of the panoramic cylindrical map, compare the features from the at least the portion of the panoramic cylindrical map to features from a pre-generated three-dimensional model of the environment to produce a set of corresponding features, and use the set of corresponding features to determine a position and an orientation of the camera.

In an embodiment, an apparatus includes means for producing at least a portion of a panoramic cylindrical map of an environment with a camera; means for extracting features from the at least the portion of the panoramic cylindrical map; means for comparing the features from the at least the portion of the panoramic cylindrical map to features from a pre-generated three-dimensional model of the environment to produce a set of corresponding features; and means for using the set of corresponding features to determine a position and an orientation of the camera.

In an embodiment, a non-transitory computer-readable medium including program code stored thereon includes program code to produce at least a portion of a panoramic cylindrical map of an environment with images captured by a camera; program code to extract features from the at least the portion of the panoramic cylindrical map; program code to compare the features from the at least the portion of the panoramic cylindrical map to features from a pre-generated three-dimensional model of the environment to produce a set of corresponding features; and program code to use the set of corresponding features to determine a position and an orientation of the camera.

### BRIEF DESCRIPTION OF THE DRAWING

FIGS. 1A and 1B below illustrate a front side and back side, respectively, of a mobile device capable of using panoramic images for real-time localization.

FIG. 2 illustrates the localization process performed by the mobile device of FIGS. 1A and 1B.

FIG. 3 is a flow chart illustrating the method of using panoramic images for real-time localization.

FIG. 4 is a flow chart illustrating a method of using a set of corresponding features to determine a position and an orientation of the camera.

FIG. 5 illustrates an unwrapped cylindrical map with a camera image frame projected and filled on the map.

FIG. 6 illustrates a wrapped cylindrical map with the position of the mobile device set at the center and shows a frame of a camera image projected onto a cylindrical map.

FIGS. 7A, 7B, and 7C illustrate how images are mapped into a panoramic map to increase the field of view for better image-based localization.

FIG. 8 illustrates the three point perspective pose estimation (P3P) problem, which is used for localizing with panoramic images.

FIGS. 9A, 9B, and 9C illustrate localization performance for varying fields of view.

FIGS. 10A and 10B illustrate the success rate of the localization procedure with respect to the angular aperture.

FIGS. 11A and 11B are similar to FIGS. 10A and 10B, but illustrate the success rate of the localization procedure with respect to the angular aperture with a manually chosen starting point.

FIG. 12 is a block diagram of a mobile device capable of using panoramic images for real-time localization.

### DETAILED DESCRIPTION

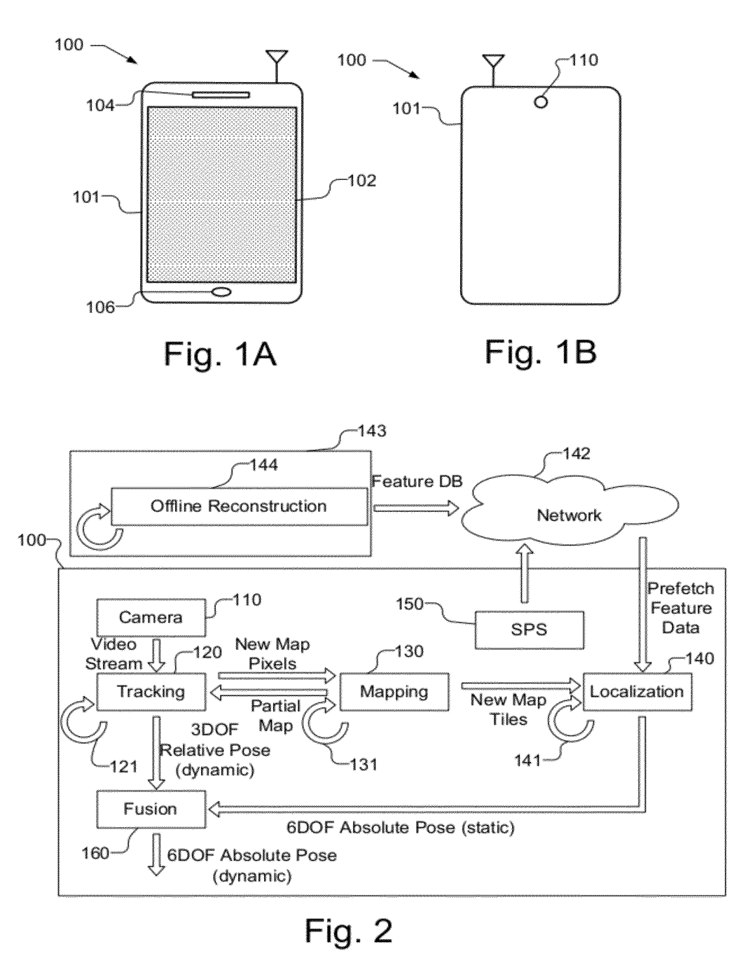

FIGS. 1A and 1B below illustrate a front side and back side, respectively, of a mobile device 100 capable of using panoramic images for real-time localization. The mobile device 100 is illustrated as including a housing 101, a display 102, which may be a touch screen display, as well as a speaker 104 and microphone 106. The mobile device 100 further includes a forward facing camera 110 to image the environment.

As used herein, a mobile device refers to any portable electronic device such as a cellular or other wireless communication device, personal communication system (PCS) device, personal navigation device (PND), Personal Information Manager (PIM), Personal Digital Assistant (PDA), or other suitable mobile device. The mobile device may be capable of receiving wireless communication and/or navigation signals, such as navigation positioning signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all electronic devices, including wireless communication devices, computers, laptops, tablet computers, etc. which are capable of AR.

Assuming pure rotational movements, the mobile device 100 may create a panoramic map from the live image stream from camera 110. For each camera image, i.e., video frame or captured image, the mobile device 100 pose is updated, based on the existing data in the map, and the map is extended by only projecting areas that have not yet been stored. A dense cylindrical panoramic map of the environment map is thus created, which provides for accurate, robust and drift-free tracking If desired, other types of panoramic map generation may be used, such as use of a panoramic camera.

FIG. 2 illustrates the localization process performed by mobile device 100. The mobile device 100 is capable of delivering high quality self-tracking across a wide area (such as a whole city) with six degrees of freedom (6DOF) for an outdoor user operating a current generation smartphone or similar mobile device. Overall, the system is composed of an incremental orientation tracking unit 120 operating with 3DOF, a mapping unit 130 that maps panoramic images, and a model-based localization unit 140 operating with absolute 6DOF, but at a slower pace. The localization unit 140 uses the panoramic image produced by mapping unit 130 relative to a pre-generated large scale three-dimensional model, which is a reconstruction of the environment. All parts of the system execute on a mobile device in parallel, but at different update rates.

At startup, the user is explores the environment through the viewfinder of the camera 110, e.g., which is displayed on display 102. Captured images are provided by the camera, e.g., in a video stream, to the feature-based orientation tracking unit 120, which updates at the video frame rate as illustrated by arrow 121. The tracking unit 120 also receives a partial map from the mapping unit 130. The tracking unit 120 determines any pixels in a current image that are not in the partial map, and provides the new map pixels to the mapping unit 130. Tracking unit 120 also uses the partial map along with the video stream from camera 110 for feature based tracking to determine the orientation of the mobile device 100 with respect to the partial map, and thus produces a relative pose of the mobile device 100 with three degrees of freedom (3DOF).

The mapping unit 130 builds a panoramic image whenever it receives previously unmapped pixels from the tracking unit 120. As mapping unit 130 generates the panoramic image, the panoramic image, sometimes referred to as a map, or a partial map is provided to the tracking unit 120. The panoramic image is subdivided into tiles. Whenever a tile is completely covered by the mapping unit 130, the new map tile is forwarded to the localization unit 140. The mapping unit 130 is updated as new map pixels are provided from tracking unit 120, as illustrated by arrow 131, and is, thus, generally updated less often than the tracking unit 120.

The localization unit 140 compares features in tiles received from mapping unit 130 with a database of sparse features from a three-dimensional reconstructed model obtained from a remote server 143 via network 142. The prefetch feature data, i.e., the pre-generated three-dimensional model or portions thereof, may be obtained based on a coarse position estimate, e.g., obtained from a Satellite Positioning System (SPS) 150, such as Global Positioning System (GPS), Galileo, Glonass or Compass or other Global Navigation Satellite Systems (GNSS) or various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. Thus, as used herein an SPS may include any combination of one or more global and/or regional navigation satellite systems and/or augmentation systems, and SPS signals may include SPS, SPS-like, and/or other signals associated with such one or more SPS. Alternatively, coarse position estimates may be obtained using other sources such as wireless signals, e.g., trilateration using cellular signals or using Received Signal Strength Indication (RSSI) measurements from access points, or other similar techniques. By providing a coarse position, the appropriate portion of the feature database generated by offline reconstruction 144 may be obtained from a remote server 143. Using the prefetch feature data from network 142 and the map tiles from mapping unit 130, the localization unit 140 generates a static absolute pose with six degrees of freedom (6DOF). Localization unit 140 is updated as new map tiles are provided from mapping unit 130 and/or new prefetch feature data is provided from the network 142, as illustrated by arrow 141, and is thus updated slower than mapping unit 130. Given a location prior and a pedestrian moving at a limited speed, current wireless wide area networks allow incremental prefetching of a reasonable amount of data for model based tracking (e.g., a few tens of megabytes per hour). The resulting bandwidth requirement is equivalent to using an online map service on a mobile device. Thus, the mobile device 100 may use this approach to download relevant portions of a pre-partitioned database on demand.

The fusion unit 160 combines the current incremental orientation pose from the tracking unit 120 with the absolute pose recovered from the panoramic map by localization unit 140. The fusion unit 160 therefore yields a dynamic 6DOF absolute pose of the mobile device 100, albeit from a semi-static position.

Computing the localization from the partial panoramic image effectively decouples tracking from localization, thereby allowing sustained real-time update rates for the tracking and a smooth augmented reality experience. At the same time, the use of the partial panoramic image overcomes the disadvantages of the narrow field of view of the camera 110, e.g., a user can improve the panorama until a successful localization can be performed, without having to restart the tracking.

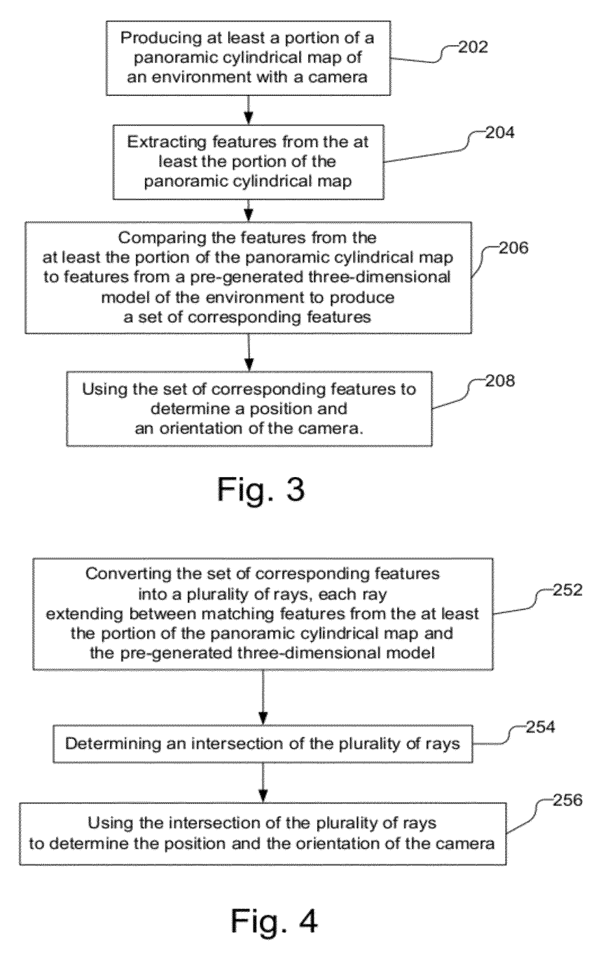

FIG. 3 is a flow chart illustrating the method of using panoramic images for real-time localization. As illustrated, at least a portion of a panoramic cylindrical map is produced of an environment using a camera (202). The camera may have a relatively narrow field of view, such as that found on mobile phones, where the panoramic cylindrical map is produced by combining multiple images from the camera. For example, a plurality of camera images may be captured by the camera as the camera rotates and the plurality of camera images are used to generate the at least the portion of the panoramic cylindrical map. The camera, however, may have a large field of view and may be a panoramic camera if desired.

Features are extracted from the at least the portion of the panoramic cylindrical map (204). The features from the at least the portion of the panoramic cylindrical map are compared to features from a pre-generated three-dimensional model of the environment to produce a set of corresponding features (206). For example, where a panoramic cylindrical map is generated using a plurality of images captured by the camera, the panoramic cylindrical map is subdivided into a plurality of tiles, and features from each tile panoramic cylindrical map is compared to the model features from the pre-generated three-dimensional model when each tile is filled using the plurality of camera images. The pre-generated three-dimensional model may be partitioned into data blocks based on visibility and associated with locations in the environment. Thus, by determining the location of the camera in the environment, e.g., using SPS 150 in FIG. 2, a data block of the pre-generated three-dimensional model may be obtained, e.g., from a remote server, using the location of the camera, wherein the features from the at least the portion of the panoramic cylindrical map are compared to the features from the data block of the pre-generated three-dimensional model of the environment. Consequently, only relatively small portions of the pre-generated three-dimensional model are obtained and stored on the mobile device at a time, thereby reducing storage demands on the mobile device.

The set of corresponding features can then be used to determine a position and an orientation of the camera (208). The determination of the position and orientation (i.e., pose) of the camera, may be based on a modified Three-Point Pose estimation. The Three Point Pose estimation is modified, however, by using a ray-based formulation, for the set of correspondences between the pre-generated three-dimensional model and the features. Three Point Pose estimation may also be modified by using an error measurement that is based on the distance on the projection surface.

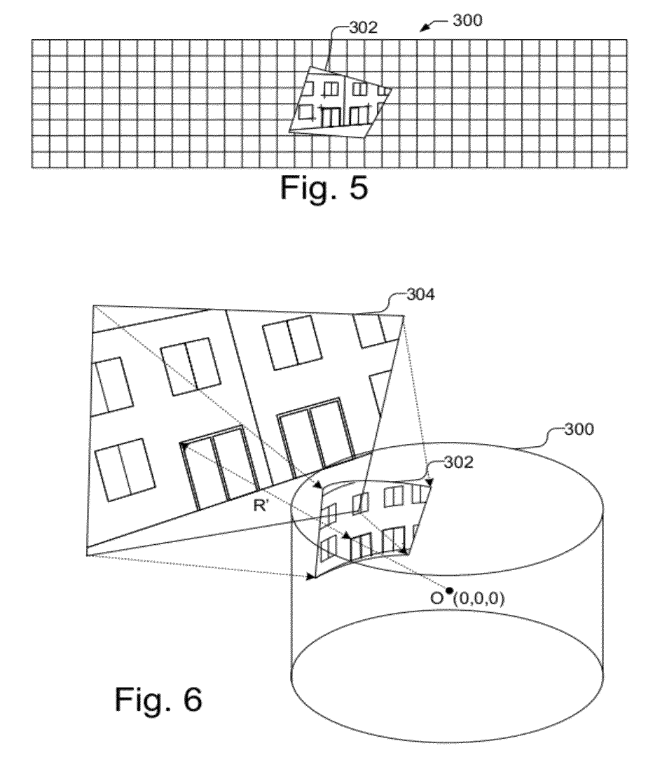

FIG. 4 is a flow chart illustrating a method of using the set of corresponding features to determine a position and an orientation of the camera (block 208 in FIG. 3). As illustrated, the set of corresponding features are converted into a plurality of rays, each ray extends between a single two-dimensional feature from the panoramic cylindrical map and a single three-dimensional feature from the pre-generated three-dimensional model (252). For example, for each feature in the panoramic cylindrical map, a ray is generated from the initial camera center (0,0,0) outwards through the pixel on the panoramic cylindrical map surface to the corresponding three-dimensional point on the pre-generated three-dimensional model. The intersection of the plurality of rays is determined (254) and the intersection of the plurality of rays is used to determine the position and the orientation of the camera (256). For example, the pose estimation may calculate a minimum solution choosing three point-ray correspondences and evaluate the solutions. The solution with the highest number of supporting correspondences provides the final pose estimate.

Additionally, the relative orientation of the camera may be tracked with respect to the at least the portion of the panoramic cylindrical map, e.g., by comparing each newly captured image to the at least the portion of the panoramic cylindrical map, and the relative orientation of the camera may be combined with the position and orientation determined using the set of corresponding features.

Thus, compared to other methods, the presently described process can be used to perform localization with little computational power and memory consumption. Due to the independent tasks of mapping, feature calculation, matching and pose estimation, multi-processor platforms may be used more efficiently. Thus, the method is well suited to mobile phone hardware. Further, by using panoramic tracking and mapping, the issue of the narrow field of view of mobile phone cameras is removed. The pose estimation based on panoramic images generates results with a high degree of accuracy and an increased field of view automatically increases the support for the final pose estimate.

The high accuracy of the pose estimate allows for the use of applications such as augmented reality with a quality considerably higher than was possible with previous methods. For example, translation and rotation errors may be reduced to within a range of a few centimeters and a few degrees, respectively.

Further details of the process of mapping, feature calculation, matching and pose estimation, as well as generation of the pre-generated three-dimensional model follows.

Panorama Generation and Tracking

High quality panorama generation is a well-known image stitching task. In most cases, the task of finding the geometrical relationship between individual images can be solved sufficiently well by determining image point correspondences, e.g. by using the well-known Scale Invariant Feature Transform (SIFT) algorithm, as also used in the AutoStitch software available for mobile phones. The majority of panorama creation methods, however, work on high-resolution still images and relies on significant amounts of computational and memory resources. Moreover, the actual process of stitching individual images together is prone to errors due to camera artifacts. It is desirable to remove seams and other visual artifacts.

The tracking unit 120 and mapping unit 130 in FIG. 2 work together to track the relative orientation of the mobile device 100 with 3DOF and simultaneously builds a cylindrical environment map. The cylindrical map is produced assuming that the user does not change position during panorama creation, i.e., only a rotational movement is considered, while the camera stays in the center of the cylinder during the entire process of panoramic mapping. A cylindrical map is used for panoramic mapping as a cylindrical map can be trivially unwrapped to a single texture with a single discontinuity on the left and right borders. The horizontal axis does not suffer from nonlinearities; however, the map becomes more compressed at the top and the bottom. The cylindrical map is not closed vertically and thus there is a limit to the pitch angles that can be mapped. This pitch angel limit, however, is acceptable for practical use as a map of the sky and ground is typically not used for tracking.

The dimensions of the cylindrical map may be set as desired. For example, with the cylindrical map's radius fixed to 1 and the height to π/2, the map that is created by unwrapping the cylinder is four times as wide as high (π/2 high and 2π wide). A power of two for the aspect ratio simplifies using the map for texturing. The map covers 360° horizontally while the range covered vertically is given by the arctangent of the cylinder's half-height (π/4), therefore [−38.15°, 38.15°]. Of course, other ranges may be used if desired.

Current mobile phones can produce multi-megapixel photos, but the live video feed is typically restricted, e.g., to 320×240 pixels. Moreover, a typical camera on a mobile phone has roughly a 60° horizontal field of view. Accordingly, if the mobile device 100 is a current mobile phone, a complete 360° horizontal panorama would be approximately 1920 pixels wide (=320 pixels/60°·360°). Thus, the resolution of the cylindrical map may be chosen to be, e.g., 2048×512 pixels, which is the smallest power of two that is larger than the camera's resolution thereby permitting the transfer of image data from the camera into the map space without loss in image quality. To increase tracking robustness lower-resolution maps (1024×256 and 512×128) may also be created as discussed below.

FIG. 5 illustrates an unwrapped cylindrical map 300 that is split into a regular grid, e.g., of 32×8 cells. Every cell in the map 300 has one of two states: either unfinished (empty or partially filled with mapped pixels) or finished (completely filled). When a cell is finished, it is down-sampled from the full resolution to the lower levels and keypoints are extracted for tracking purposes. FIG. 5 illustrates a first camera image frame 302 projected and filled on the map 300. The crosses in the first camera image frame 302 mark keypoints that are extracted from the image. Keypoints may be extracted from finished cells using the FAST (Features from Accelerated Segment Test) corner detector. Of course, other methods for extracting keypoints may be used, such as SIFT, or Speeded-up Robust Features (SURF), or any other desired method.

The current camera image is projected into the panoramic map space (202). Projecting the current camera image onto a cylindrical map assumes pure rotational motion of the mobile device 100, which is particularly valid where distance between the mobile device 100 and the objects in the environment is large compared to any involuntary translational motion that occurs when rotating the mobile device 100 and, therefore, errors are negligible. Moreover, a user may be trained to effectively minimize parallax errors. The mobile device 100 position may be set to the origin O (0,0,0) at the center of the mapping cylinder. FIG. 6, by way of example, illustrates a wrapped cylindrical map 300 with the position of the mobile device 100 set at the origin O (0,0,0) and shows a frame 302 of a camera image 304 projected onto a cylindrical map 300. A fixed camera position leaves 3 rotational degrees of freedom to estimate for correctly projecting camera images onto the cylindrical map 300. Depending on the availability of motion sensors, such as accelerometers, in the mobile device 100, the system may be either initialized from the measured roll and pitch angles of the mobile device a roughly horizontal orientation may be assumed.

Of course, because the cylindrical map is filled by projecting pixel data from the camera image onto the map, the intrinsic and extrinsic camera parameters should calibrated for an accurate mapping process. Assuming that the camera 110 does not change zoom or focus, the intrinsic parameters can be estimated once using an off-line process and stored for later use. For example, the principle point and the focal lengths for the camera 110 in the x and y directions are estimated. Cameras in current mobile phones internally typically correct most of the radial distortion introduced by the lens of the camera. However, some distortion may remain, so additional correction may be useful. To measure such distortion parameters, an image of a calibration pattern may be taken and evaluated with known camera calibration processes, such as the Caltech camera calibration toolbox. Additional corrections may be performed, such as correcting artifacts due to vignetting, which consists of a reduction in pixel intensities at the image periphery. Vignetting can be modeled with a non-linear radial falloff, where the vignette strength is estimated by taking a picture of a diffusely-lit white board. The average intensities close to all the four corners are measured and the difference from the image center is noted.

While the user rotates the mobile device 100, consecutive frames from the camera 110 are processed. Given a known (or assumed) camera orientation O, forward mapping is used to estimate the area of the surface of the cylindrical map 300 that is covered by the current camera image. Given a pixel's device coordinate P, i.e., the coordinates in the image sensor, a 3D ray R is calculated as follows:

R=π′(δ′(K⁻¹P)) eq. 1

The pixel's device coordinate P is transformed into an ideal coordinate by multiplying it with the inverse of the camera matrix K and removing radial distortion using a function δ′. The resulting coordinate is then unprojected into the 3D ray R using the function π′ by adding a z-coordinate of 1. The ray R is converted into a 2D map position Mas follows:

M=μ(t(O⁻¹R,C)) eq. 2

The 3D ray R is rotated from map space into object space using the inverse of the camera rotation matrix O⁻¹. Next, the ray is intersected with the cylinder using a function ι to get the pixel's 3D position on the cylindrical map 300. Finally, the 3D position is converted into the 2D map position Musing a function μ, which converts a 3D position into a 2D map, i.e., converting the vector to a polar representation.

A rectangle defined by the corners of the frame 302 of the camera image 304 is forward mapped onto the cylindrical map 300, as illustrated in FIG. 6 and discussed above. The first camera image may be forward mapped to the center of the cylindrical map, as illustrated in FIG. 5. Each subsequent camera image is aligned to the map by extracting and matching features from the camera image and the map as discussed above. Once the position of the camera image on the map is determined, a frame for the camera image, e.g., frame 302 in FIG. 6, is projected onto the cylindrical map 300. The frame 302 may be used to define a mask for the pixels of the map 300 that are covered by the current camera image 304. Due to radial distortion and the nonlinearity of the mapping, each side of the rectangular frame 302 may be sub-divided three times to obtain a smooth curve in the space of the cylindrical map 300.

The forward-mapped frame 302 provides an almost pixel-accurate mask for the pixels that the current image can contribute. However, using forward mapping to fill the map with pixels can cause holes or overdrawing of pixels. Thus, the map is filled using backward mapping. Backward mapping starts with the 2D map position M′ on the cylinder map and produces a 3D ray R′ as follows:

R′=O*μ′(M′) eq. 3

As can be seen in equation 3, a ray is calculated from the center of the camera using function μ′, and then rotating the using the orientation O, resulting in ray R′. The ray R′ is converted in to device coordinates P′ as follows:

P′=K*δ(π(R′)) eq. 4

The ray R′ is projected onto the plane of the camera image 304 using the function IC, and the radial distortion is applied using function 6, which may be any known radiation distortion model. The resulting ideal coordinate is converted into a device coordinate P′ via the camera matrix K. The resulting coordinates typically lies somewhere between pixels, so linear interpolation is used to achieve a sub-pixel accurate color. Finally, vignetting may be compensated and the pixel color is stored in cylindrical map.

A single 320×240 pixel camera image will require back projecting roughly 75,000 pixels, which is too great a workload for typical current mobile devices. To increase the speed of the process, each pixel in the cylindrical map 300 may be set only a limited number of times, e.g., no more than five times, so that backward mapping occurs a limited number of times for each pixel. For example, in one embodiment, each pixel may be set only once, when it is backward mapped for the first time. Thus, when panoramic mapping is initiated, the first camera image requires a large number of pixels to be mapped to the cylindrical map. For example, as illustrated in FIG. 5, the entire first camera image frame 302 is mapped onto cylindrical map 300. For all subsequent camera images, however, fewer pixels are mapped. For example, with slow camera movement, only a few rows or columns of pixels will change per camera image. By mapping only unmapped portions of the cylindrical map, the required computational power for updating the map is significantly reduced. By way of example, a camera (with a resolution of 320×240 pixels and a field of view of 60°) that is horizontally rotating by 90° in 2 seconds will produce only approximately 16 pixel columns—or 3840 pixels—to be mapped per frame, which is only 5% of an entire camera image.

To limit setting each pixel in the cylindrical map 300 only a number of times, e.g., once, a mapping mask is updated and used with each camera image. The mapping mask is used to filter out pixels that fall inside the projected camera image frame but that have already been mapped. The use of a simple mask with one entry per pixel would be sufficient, but would be slow and memory intensive. A run-length encoded (RLE) mask may be used to store zero or more spans per row that define which pixels of the row are mapped and which are not. A span is a compact representation that only stores its left and right coordinates. Spans are highly efficient for Boolean operations, which can be quickly executed by simply comparing the left and right coordinates of two spans. If desired, the mapping mask may be used to identify pixels that have been written more than five times, thereby excluding those pixels for additional writing. For example, the mapping mask may retain a count of the number of writes per pixel until the number of writes is exceeded. Alternatively, multiple masks may be used, e.g., the current mapping mask and the previous four mapping masks. The multiple masks may be overlaid to identify pixels that have been written more than five times. Each time a pixel value is written (if more than once but less than five), the projected pixel values each may be statistically combined, e.g., averaged, or alternatively, only pixel values that provide a desired quality mapping may be retained.

Thus, with consecutive frames, only the area in the panoramic map 300 that has not yet been mapped is extended with new pixels. The map is subdivided into tiles of 64×64 pixels. Whenever a tile is entirely filled, the contained features are added to the tracking dataset.

The tracking unit 120 uses the panorama map to track the rotation of the current camera image. The tracking unit 120 extracts features found in the newly finished cells in the panorama map and new camera images. The keypoint features are extracted using the FAST corner detector or other feature extraction techniques, such as SIFT, SURF, or any other desired method. The keypoints are organized on a cell-level in the panorama map because it is more efficient to extract keypoints in a single run once an area of a certain size is finished. Moreover, extracting keypoints from finished cells avoids problems associated with looking for keypoints close to areas that have not yet been finished, i.e., because each cell is treated as a separate image, the corner detector itself takes care to respect the cell's border. Finally, organizing keypoints by cells provides an efficient method to determine which keypoints to match during tracking.

The map features are then matched against features extracted from a current camera image. An active-search procedure based on a motion model may be applied to track keypoints from one camera image to the following camera image. Accordingly, unlike other tracking methods, this tracking approach is generally drift-free. However, errors in the mapping process may accumulate so that the map is not 100% accurate. For example, a map that is created by rotating a mobile device 100 by a given angle α may not be mapped exactly to the same angle α in the database, but rather to an angle α+δ. However, once the map is built, tracking is as accurate as the map that has been created.

To estimate the current camera orientation, the tracker initially uses a rough estimate. In the first camera image, the rough estimate corresponds to the orientation used for initializing the system. For all successive camera images, a motion model is used with constant velocity to estimate an orientation. The velocity is calculated as the difference in orientation between one camera image and the next camera image. In other words, the initial estimate of orientation for a camera image that will be produced at time t+1 is produced by comparing the current camera image from time t to immediately preceding camera image from time t−1.

Based on the initial rough estimate orientation, a camera image is forward projected onto the cylindrical map to find finished cells in the map that are within the frame of the camera image. The keypoints of these finished cells are then back projected onto the camera image. Any keypoints that are back projected outside the camera image are filtered out. Warped patches, e.g., 8×8 pixel, are generated for each map keypoint by affinely warping the map area around the keypoint using the current orientation matrix. The warped patches represent the support areas for the keypoints as they should appear in the current camera image.

The tracking unit 120 may use normalized cross correlation (over a search area) at the expected keypoint locations in the camera image. Template matching is slow and, thus, the size of the search area is limited. A multi-scale approach is applied to track keypoints over long distances while keeping the search area small. For example, the first search is at the lowest resolution of the map (512×128 pixels) against a camera image that has been down-sampled to quarter size (80×60 pixels) using a search radius of 5 pixels. The coordinate with the best matching score is then refined to sub-pixel accuracy by fitting a 2D quadratic term to the matching scores of the 3×3 neighborhood. Because all three degrees of freedom of the camera are respected while producing the warped patches, the template matching works for arbitrary camera orientations. The position of the camera image with respect to the map is thus refined and the camera image is forward projected into map space as discussed above.

Moreover, based on the refined position of the camera image, the orientation of the mobile device is then updated. The correspondences between the 3D cylinder coordinates and the 2D camera coordinates are used in a non-linear refinement process with the initial orientation guess as a starting point. The refinement may use Gauss-Newton iteration, where the same optimization takes place as that used for a 6-degree-of-freedom camera pose, but position terms are ignored and the Jacobians are only calculated for the three rotation parameters. Re-projection errors and inaccuracies may be dealt with effectively using an M-estimator. The final 3×3 system is then solved using Cholesky decomposition.

Starting at a low resolution with only a few keypoints and a search radius of 5 pixels allows correcting gross orientation errors efficiently but does not deliver an orientation with high accuracy. The orientation is therefore refined again by matching the keypoints from the medium-resolution map (1024×512 pixels) against a half-resolution camera image (160×120 pixels). Since the orientation is now much more accurate than the original estimate, the search area is restricted to a radius of 2 pixels only. Finally, another refinement step is executed at the full resolution map against the full-resolution camera image. Each successive refinement is based on larger cells and therefore uses more keypoints than the previous refinement. In the last step several hundred keypoints are typically available for estimating a highly accurate orientation.

Re-localization is used when the tracker fail to track the keypoints and re-initialization at an arbitrary orientation is necessary. The tracker may fail, e.g., if the tracker does not find enough keypoints, or when the re-projection error after refinement is too large to trust the orientation. Re-localization is performed by storing low-resolution keyframes with their respective camera orientation in the background, as the cylindrical map is being created. In case the tracking is lost, the current camera image is compared to the stored low-resolution keyframes using normalized cross correlation. To make the matching more robust both the keyframes (once, they are stored) and the camera image are blurred. If a matching keyframe is found, an orientation refinement is started using the keyframe's orientation as a starting point.

In order to limit the memory overhead of storing low-resolution keyframes, the camera image may be down sampled to quarter resolution (80×60 pixels). Additionally, re-localization tracks the orientation already covered by a keyframe. For example, the orientation is converted into a yaw/pitch/roll representation and the three components are quantized into 12 bins for yaw (±180°), 4 bins for pitch (±30°) and 6 bins for roll (±90°). Storing only ±90° for roll is a contribution to the limited memory usage but results in not being able to recover an upside-down orientation. For each bin a unique keyframe is stored, which is only overwritten if the stored keyframe is older than 20 seconds. In the described configuration, the relocalizer requires less than 1.5 MByte of memory for a full set of keyframes.

Generating a panoramic map by mapping unit 130 and the tracking unit 120 is described further in, e.g., U.S. Ser. No. 13/112,876, entitled “Visual Tracking Using Panoramas on Mobile Devices,” filed May 20, 2011, by Daniel Wagner et al., which is assigned to the assignee of the assignee hereof and which is incorporated herein by reference.

Reconstruction and Global Registration

The reconstruction of urban environments is a large field of research. Powerful tools are available for public use that help in fulfilling this task automatically. The task of accurately aligning the reconstructions with respect to the real world can be done semi-automatically using GPS priors from the images used for reconstruction.

Structure from Motion

The offline reconstruction 144 in FIG. 2 may be performed using any suitable method which enables the calculation of the positions of the camera from the image material from which a reconstruction is built. One suitable method for offline reconstruction 144 is the well-known Structure from Motion method, but non-Structure from Motion methods may be used as well. For example, one suitable reconstruction method is described by M. Klopschitz, A. Irschara, G. Reitmayr, and D. Schmalstieg in “Robust Incremental Structure from Motion,” In Int. Symposium on 3D Data Processing, Visualization, and Transmission (3DPVT), 2010, which is incorporated herein by reference. The 3D reconstruction pipeline consists of three major steps. (i) An epipolar graph GE is created with images as nodes and correspondences verified by epipolar geometry as edges. The feature matching process is accelerated with a bag of words approach. (ii) This graph is transformed into a graph GT of triplet reconstructions. The nodes in this graph are all trifocal reconstructions created from GE and are connected by overlapping views. These connections, i.e., edges, of GT are created when triplets share at least one view and pass a test for 3D point compatibility. The feature correspondences of triplets are established by using tracks from the overlapping views. (iii) These edges of GT are then merged incrementally into reconstructions, while loop closing is handled implicitly.

Another reconstruction method that may be used is the Bundler software, as described by Noah Snavely, Steven M. Seitz, Richard Szeliski in “Photo Tourism: Exploring image collections in 3D”, ACM Transactions on Graphics Proceedings of SIGGRAPH 2006, 2006, which is incorporated herein by reference. Other reconstructions processes, however, may be used as well.

Global Registration

All reconstruction data may not be fully available when the reconstruction process starts. Accordingly, global registration of multiple partial reconstructions may be used. When building a global reconstruction from several individual reconstructions, they must all be aligned in a common global coordinate system. This could be done, e.g., by manually providing an initial rough alignment, then refining automatically. If desired, fully automatic processes may be used. Providing an initial alignment can be done very quickly with a suitable map tool, and prevents pathological errors resulting from too sparse image coverage and repetitive structures.

To refine the alignment of two reconstructions, matches are calculated for each image in the first reconstruction to 3D features in the second reconstruction. From these matches, an initial pose estimate for the image in the first reconstruction with respect to the second reconstruction is obtained. The manual alignment is used to verify that the estimated pose is correct.

Using this approach, verified links can be generated between individual, initially not related reconstructions. The result of the manual alignment is improved by using bundle-adjustment to reduce the reprojection error.

Visibility Partitioning

Since feature database sizes grow with the covered area, the data may be partitioned, e.g., to accommodate the storage limitations of mobile devices. Blocks may be created on a heuristically generated irregular grid to partition the reconstruction into smaller parts. Feature scale and estimated surface normal vectors could be added easily as additional visibility cues. The partitioning of data blocks is on the one hand driven by visibility considerations and on the other hand by the accuracy of GPS receivers.

Most of the features in an external urban database are generated from patches extracted from building facades and are therefore coplanar with the building facades. These features can only be matched within a certain angular range. In general, the range depends on the capabilities of the feature detector, but an angle smaller than ±40° appears to be reasonable in practice. This angular constraint is often violated when looking down a street and viewing facades at a steep angle. In this case, which is quite frequent in practice, only a small area of the panorama that depicts the near street side contains useful features, while further away features are not “visible” (i.e., they cannot be reliably detected). We empirically determined a feature block size of at most 20 meters along road direction and covering both sides of the road yields best results in some environments. By way of example, such a block size contains approximately 15,000 features on average, which is around 2.2 MB of memory. Of course, in other environments, the feature block size, as well as the feature density, may differ.

An additional justification for the choice of block size is motivated by the accuracy of consumer-grade SPS receivers available in current mobile devices. The accuracy of SPS estimates is in the range of 10 to 20 meters. Given a SPS prior, the correct feature block can be determined easily. To account for inaccuracies, the neighboring blocks may be considered as well. With this choice, the environment around an initial SPS-based position estimate is represented in a sufficiently reliable way for computing 6DOF localization.

Localization from Panoramic Images

The localization unit 140 in FIG. 2 compares features in completed tiles in the panoramic map generated by mapping unit 130 with a database of sparse features from the 3D reconstructed model obtained from network 142. The localization unit 140 uses the panoramic map in order to effectively increase the field of view which increases the robustness for localization. As used herein, the field of view is used interchangeably with the angular aperture in the horizontal direction. In optics, the angular aperture has a slightly different meaning than field of view; however, in the context of a cylindrical model for the panorama creation as used herein, the field of view directly corresponds to the arc of the cylinder circle.

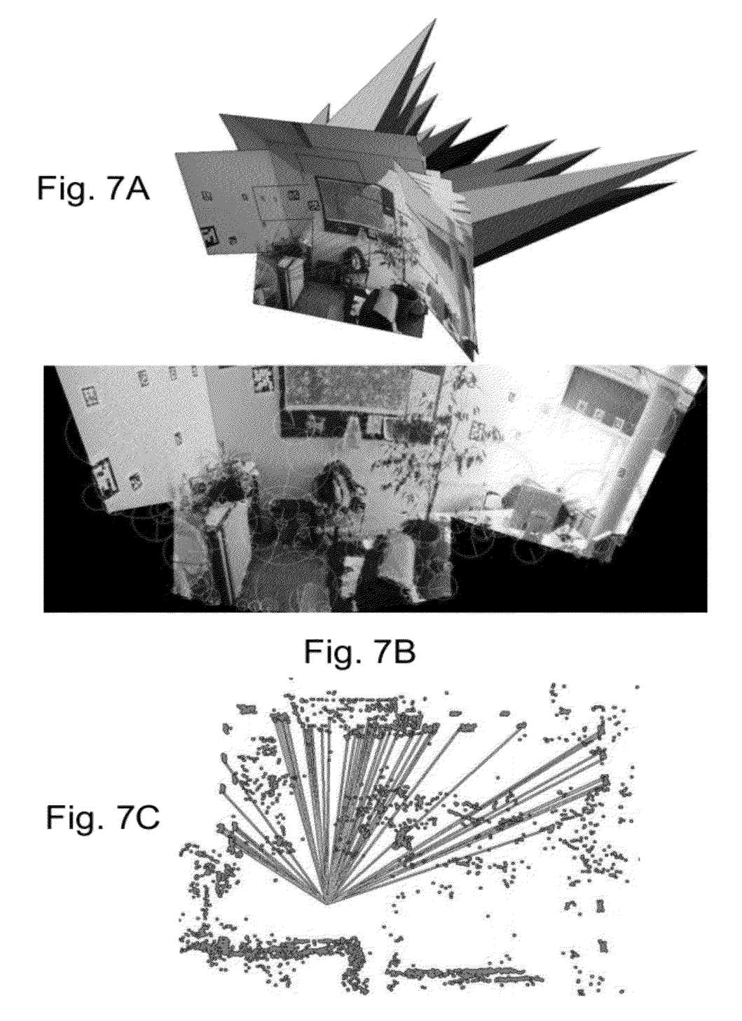

FIGS. 7A, 7B, and 7C illustrate how images are mapped into a panoramic map to increase the field of view for better image-based localization. FIG. 7A illustrates the relative orientation of a number of images with the same projection center. FIG. 7B illustrates feature points that are extracted in the blended cylinder projection of the images from FIG. 7A. FIG. 7C illustrates inlier feature matches for the panoramic image after robust pose estimation against a small office test database, where the lines connect the center of the projection with the matched database points.

A partial or complete panorama can be used for querying the feature database. Features extracted from the panoramic image are converted into rays and used directly as input for standard 3-point pose estimation. An alternative approach may be to use the unmodified source images that were used to create the panorama and create feature point tracks. These tracks can be converted to rays in space using the relative orientation of the images. Using the panoramic image, however, reduces complexity and lowers storage requirements.

Three Point Pose Estimation

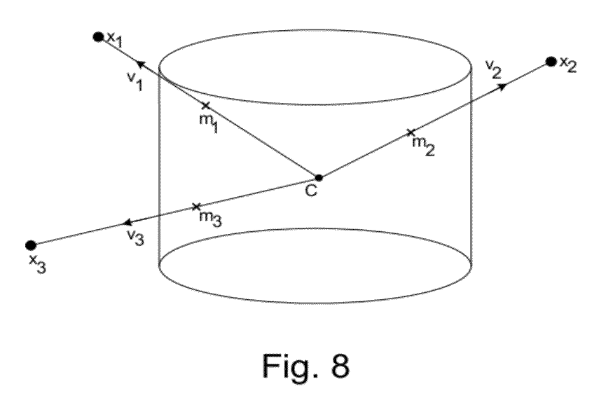

FIG. 8 illustrates the three point perspective pose estimation (P3P) problem, which is used for localizing with panoramic images. The geometry of the P3P problem can be seen in FIG. 8. The geometry of the P3P problem for panoramic camera models is the same as for pinhole models. For pinhole camera models, a known camera calibration means that the image measurements mᵢ can be converted to rays vᵢ and their pairwise angle ∠(vᵢ,vⱼ) can be measured. In the present application, three known 3D points Xᵢ and their corresponding image measurements mᵢ on the panoramic map give rise to three pairwise angle measurements. These are sufficient to compute a finite number of solutions for the camera location and orientation. Converting the panoramic image measurements mᵢ to rays vᵢ and thus pairwise angle measurements ∠(vᵢ,vⱼ) leads to the same equation system as in the pinhole case, and thus, the law of cosines relates the unknown distances of 3D points and the camera center xᵢ=∥C−Xᵢ∥ with the pairwise angles ∠(vᵢ,vⱼ) of the image measurement rays.

For three observed 3D points Xᵢ the pairwise 3D point distances lᵢⱼ can be computed. Furthermore, the angles between pairs of image measurements θᵢⱼ are known from the corresponding image measurements mᵢ. The unknowns are the distances xᵢ between the center of projection C and the 3D point Xᵢ:

lᵢⱼ=∥Xᵢ−Xⱼ∥

θᵢⱼ=∠(vᵢ−vⱼ)

xᵢ=∥C−Xᵢ∥. eq. 5

Using the law of cosines, each of the three point pairs gives one equation:

lᵢⱼ²+xᵢ²+xⱼ²−2xᵢxⱼ cos θᵢⱼ eq. 6

This is the same polynomial system as in the case of the more commonly used pinhole camera model and can be solved with the same well known techniques. The main difference is that in the pinhole case the camera calibration matrix K is used to convert image measurements to vectors and therefore pairwise Euclidean angle measurements, while in the present application, the rays are defined by the geometry of the cylindrical projection.

Optimization

The three point pose estimation is used in a RANSAC scheme to generate hypotheses for the pose of the camera. After selecting inlier measurements and obtaining a maximal inlier set, a non-linear optimization for the pose is applied to minimize the reprojection error between all inlier measurements mᵢ and their corresponding 3D points Xᵢ.

To avoid increasing error distortions towards the top and bottom of the panoramic image, a meaningful reprojection error is defined that is independent of the location of the measurement mᵢ on the cylinder. We approximate the projection locally around the measurement direction with a pinhole model. We apply a constant rotation Rᵢ to both the measurement ray vᵢ and the camera pose to move the measurement ray into the optical axis. The rotation Rᵢ is defined such that

Rᵢvᵢ=(0 0 1)^{T}. eq. 7

The remaining degree of freedom can be chosen arbitrarily. This rotation Rᵢ is constant for each measurement ray vᵢ and therefore not subject to the optimization.

The imaging model for the corresponding 3D point Xᵢ is then given by

$$( \begin{matrix}u \\ v\end{matrix} ) = proj ( {R}_{i} {TX}_{i} ) , where \\ proj ( {( xyz )}^{T} ) = ( \begin{matrix}\frac{x}{z} \\ \frac{y}{z}\end{matrix} ) , \qquad e8q .$$

and T is the camera pose matrix representing a rigid transformation.

The optimization minimizes the sum of all squared reprojection errors as a function of the camera pose matrix T:

$$\begin{matrix}E ( T ) = {\sum }_{i} {‖ proj ( {R}_{i} {v}_{i} ) - proj ( {R}_{i} {TX}_{i} ) ‖}^{2} \\ = {\sum }_{i} {‖ proj ( {R}_{i} {TX}_{i} ) ‖}^{2}\end{matrix} \qquad eq . 9$$

It should be noted that the rotation Rᵢ rotates the measurement into the optical axis of the local pinhole camera and therefore the projection proj(Rᵢvᵢ)=(0 0)^{T}. The camera pose matrix T is parameterized as an element of SE(3), the group of rigid body transformations in 3D. The solution Tₘᵢₙ

Tₘᵢₙ=arg_{T}minE(T) eq. 10

is found through iterative non-linear Gauss-Newton optimization.

### Experiments

In the following, an evaluation is presented of results illustrating several aspects of the present work.

Localization Database and Panoramic Images

As the raw material for the localization database, we collected a large set of images from the city center of Graz, Austria. A Canon EOS 5D SLR camera with a 20 mm wide-angle lens was used, and 4303 images were captured at a resolution of 15M pixels. By using the reconstruction pipeline described above, a sparse reconstruction containing 800K feature points of the facades of several adjacent streets was created. As natural features, we use a scalespace based approach. The entire reconstruction was registered manually with respect to a global geographic coordinate system, and partitioned into 55 separate feature blocks. These blocks were combined again into 29 larger sections according to visibility considerations.

For studying our approach, we also created a set of reference panoramic images. We captured a set of 204 panoramas using a Point Grey Ladybug 3 spherical camera. The images were captured along a walking path through the reconstructed area, and were resized to 2048×512 pixels to be compatible with our localization system. Note that we did not enforce any particular circumstances for the capturing of the reference panoramic images, rather they resemble casual snapshots. The reference images and the images used for reconstruction were taken within a time period of about 6 weeks, while the imaging conditions were allowed to change slightly.

Since the spherical camera delivers ideal panoramic images, the results might not resemble realistic conditions for a user to capture a panorama. For this reason we additionally captured a set of 80 images using the panorama mapping application described above. These images were taken about one year after the acquisition of both other datasets, so a significant amount of time had passed. The capturing conditions were almost the same, i.e. high noon and partially cloudy sky. The images expose a high amount of clutter and a high amount of noise due to exposure changes of the camera. An important fact is that in almost all images only one side of the street could be mapped accurately. This arises from the violated condition of pure rotation around the camera center during mapping.

Some details about the reconstruction and test images are summarized in Table 1.

Aperture Dependent Localization Performance

By using our panorama generation method, the handicap of the narrow field of view of current mobile phone cameras can be overcome. However, a question remains with respect to how the success of the localization procedure and the localization accuracy relates to the field of view of a camera in general.

We ran an exhaustive number of pose estimation tests given our set of panoramic images to measure the dependence of the localization success rate on the angular aperture. We modeled a varying field of view by choosing an arbitrary starting point along the horizontal axis in the panoramic image, and by limiting the actually visible area to a given slice on the panoramic cylinder around this starting point. In other words, only a small fraction of the panoramic image relating to a given field of view around the actual starting point is considered for pose estimation. The angular aperture was incrementally increased in steps of 5° from 30° to 360°.

We hypothesize that in urban scenarios, the localization procedure is likely to fail if the camera with a small FOV is pointing down a street at a steep angle. The same procedure is more likely to be successful if the camera is pointing towards a facade. Consequently, the choice of the starting point is crucial for the success or failure of the pose estimation procedure, especially for small angular apertures. To verify this assumption, we repeated the random starting point selection five times, leading to a total of 68,340 tests.

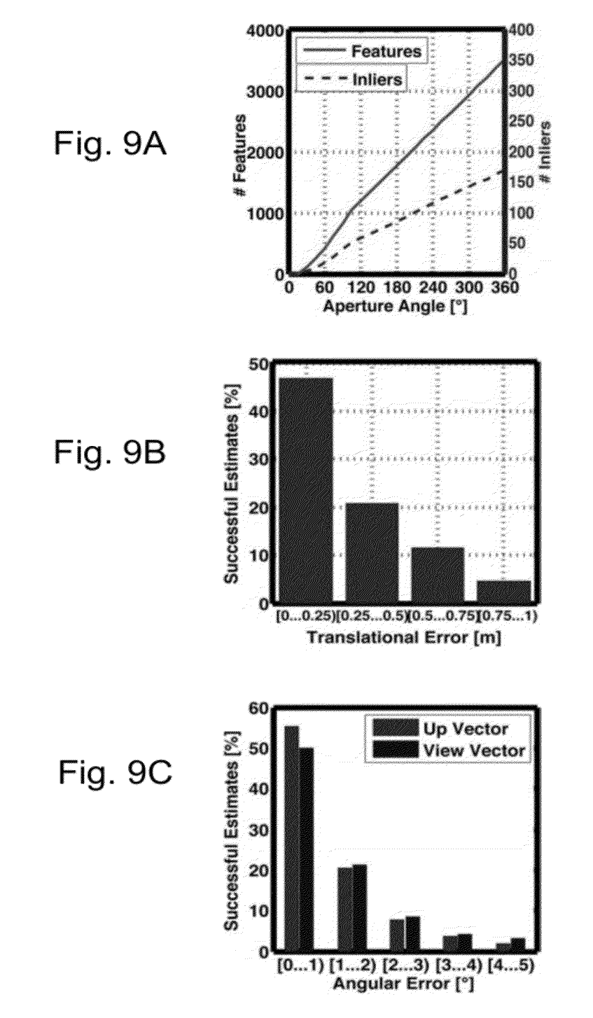

FIGS. 9A, 9B, and 9C illustrate localization performance for varying fields of view. In FIG. 9A, the total number of inliers and features is shown. The number of inliers is approximately 5% of the number of features detected in the entire image. In FIGS. 9B and 9C, the translational and rotational errors of all successful pose estimates are depicted. Due to the robustness of the approach, it is unlikely that a wrong pose estimate is computed; in ill-conditioned cases the pose estimation cannot establish successful matches and fails entirely. As ground truth, we consider the pose estimate with the most inliers calculated from a full 360 panoramic image. The translational error is in the range of several centimeters, while the rotational error is below 5°. This indicates that the pose estimate is highly accurate if it is successful.

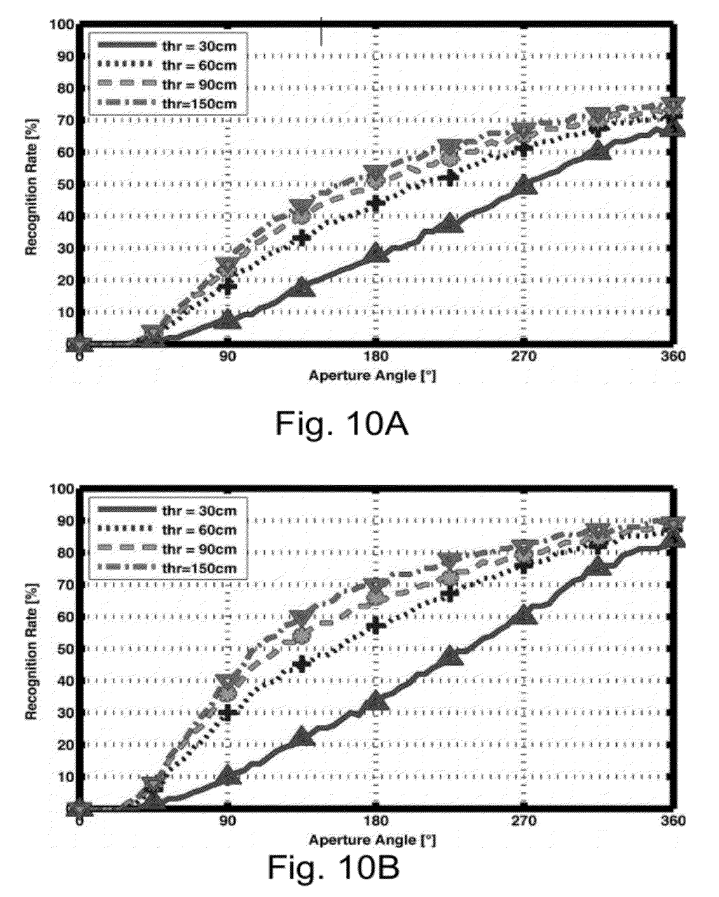

FIGS. 10A and 10B illustrate the success rate of the localization procedure with respect to the angular aperture. We measured the localization performance considering different thresholds for the translation error to accept or reject a pose as being valid. To measure the difference between tree-based matching approach and a brute-force based feature matching approach, the results for both approaches are depicted in FIGS. 10A and 10B, respectively. The tree-based approach has an approximately 5-10% lower success rate. Since building facades expose a high amount of redundancy, the tree based matching is more likely to establish wrong correspondences. Thus a lower success rate is reasonable. For a small threshold, the performance is almost linearly dependent on the angular aperture. Thus, for solving the localization task, the field of view should be as wide as possible, i.e. a full 360° panoramic image in the ideal case. An additional result is that for a small field of view and an arbitrarily chosen starting point (corresponding to an arbitrarily camera snapshot), the localization procedure is only successful in a small number of cases. Even if the snapshot is chosen to contain parts of building facades, the localization approach is still likely to fail due to the relatively small number of matches and even smaller number of supporting inliers. With increasing aperture values all curves converge. This is an indication that the pose estimates get increasingly accurate.

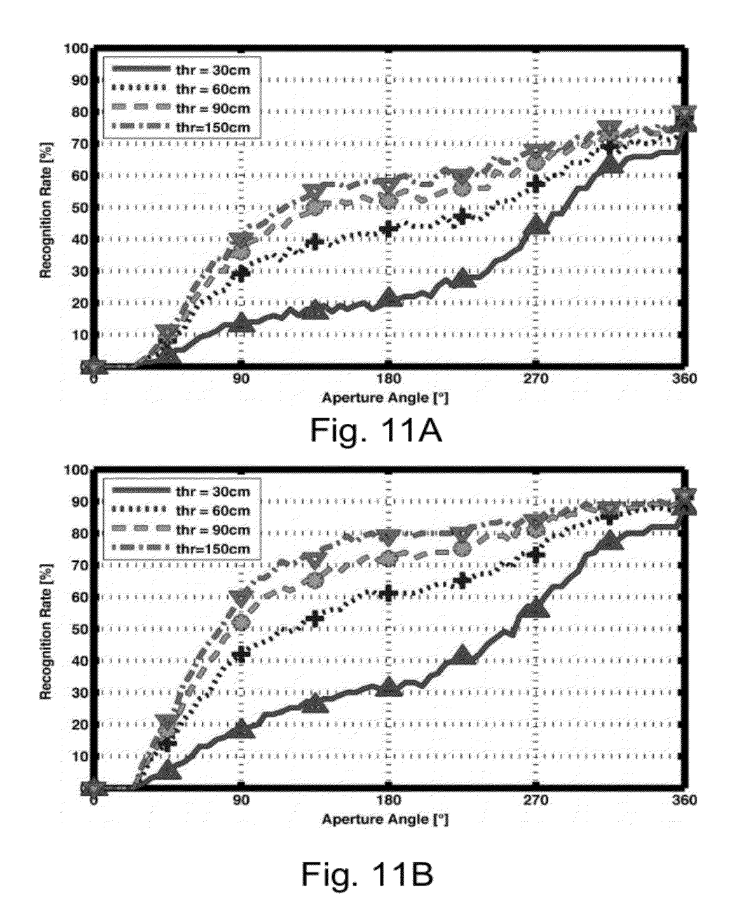

By now we only considered random starting points for capturing the panorama. However, a reasonable assumption is that the user starts capturing a panoramic snapshot while pointing the camera towards building facades intentionally rather than somewhere else. Thus we defined a set of starting points manually for all our reference images and conducted the previous experiment again. FIGS. 11A and 1 lB are similar to FIGS. 10A and 10B, but show the success rate for both matching approaches given different thresholds and a manually chosen starting point. For small aperture values, the success rate is between 5 and 15% higher than for randomly chosen starting points, if the threshold on pose accuracy is relaxed (compared to FIGS. 10A and 10B respectively). This result implies that successful pose estimates can be established more easily, but at the expense of a loss of accuracy. Since the features are not equally distributed in the panoramic image, the curves become saturated in the mid-range of aperture values, mostly due to insufficient new information being added at these angles. For full 360 panoramic images, the results are identical to the ones achieved in the previous experiments.

Pose Accuracy

For measuring the pose accuracy depending on the angular aperture, we ran a Monte-Carlo simulation on a sample panoramic image. Again, we simulated different angular apertures from 30° to 360° in steps of 5°. For each setting, we conducted 100,000 runs with random starting points, perturbing the set of image measurements with Gaussian noise of 2σ. This corresponds to a measurement error for features in horizontal and vertical direction of at most ±5 pixels.

The resulting pose estimates for different settings of the aperture angle were considered with a translational error of at most 1 m. For a small field of view, all pose estimates were distributed in a circular area with a diameter of about 2 m. With increasing values of the aperture angle, the pose estimates cluster in multiple small centers. For a full panoramic image, all pose estimates converge into a single pose with minimal variance.

There are multiple reasons for this behavior. First, for a small field of view, only a small part of the environment is visible and can be used for pose estimation. A small field of view mainly affects the estimation of object distance, which, in turn, reduces the accuracy of the pose estimate in the depth dimension. A second reason for inaccurate results is that the actual view direction influences the quality of features used for estimating the pose, especially for a small field of view. Since the features are non-uniformly distributed, for viewing directions towards facades, the estimation problem can be constrained better due to a higher number of matches. In contrast, for a camera pointing down a street at a steep angle, the number of features for pose estimation is considerably lower, and the pose estimation problem becomes more difficult. Finally, due to the least squares formulation of the pose estimation algorithm, random noise present in the feature measurements gets less influential for increasing aperture angles. As a consequence, the pose estimates converge to multiple isolated positions. These images already cover large parts of the panoramic view (50-75% of the panorama). A single common estimate is maintained for full 360 panoramic images.

Runtime Estimation

Runtime measurements were taken for parts of the process using a Nokia N900 smartphone featuring an ARM Cortex A8 CPU with 600 MHz and 1 GB of RAM. The results were averaged over a localization run involving 10 different panoramic images. The results of this evaluation are given in Table 2.

TABLE 2

| Test Results | | Process | Time [ms] |
|---|---|---|---|
| # of images | 10 | Feature Extraction | 3201.1 |
| | | | (11.75/tile) |
| Avg. # of features | 3008 | Matching | 235.9 |
| | | | (0.9/tile) |
| Ave. # of matches | 160 | Robust Pose Estimation | 39.0 |
| Avg. # of inliers | 76 | First frame (15 tiles) | <230 |

The feature extraction process consumes the largest fraction of the overall runtime. Since the panoramic image is filled incrementally in an online run, the feature extraction process can be split up to run on small image patches (i.e., the newly finished tile in the panorama caption process). Given a tile size of 64×64 pixels, the average time for feature extraction per tile is around 11.75 ms. As features are calculated incrementally, the time for feature matching is split up accordingly to around 0.92 ms per cell. To improve the accuracy of the pose estimate, the estimation procedure can be run multiple times as new matches are accumulated over time.

Given an input image size of 320×240 pixels and a tile size of 64×64 pixels, the estimated time for the first frame being mapped is around 230 ms. This time results from the maximum number of tiles finished at once (15), plus the time for matching and pose estimation. The average time spent for localization throughout all following frames can be estimated similarly by considering the number of newly finished tiles. However, this amount of time remains in the range of a few milliseconds.

Panoramas Captured Under Realistic Conditions

To test the performance of the process on images captured under realistic conditions, the localization approach was run on the second test set of 80 panoramas captured by the mapping application. Although a significant amount of time had passed between the initial reconstruction and the acquisition of the test dataset, using exhaustive feature matching the approach was successful in 51 out of 80 cases (63.75%). The tree-based matching approach was successful in 22 of 80 cases (27.5%). A pose estimate was considered successful if the translational error was below 1 m and the angular error was below 5°. These results mainly align with the results discussed above. The tree-based matching approach is more sensitive to changes of the environment and the increasing amount of noise respectively, which directly results in inferior performance.

Augmented Reality

Real-time augmented reality applications using the present method on current mobile phone hardware results in 3D models that are accurately registered with the real world environment. Minor errors are mainly caused by parallax effects resulting from the incorrect assumption that the panorama is produced using pure rotational movement around the center of projection. This assumption does not fully hold all the time, and small errors become apparent especially for close-by objects where parallax effects are more evident.

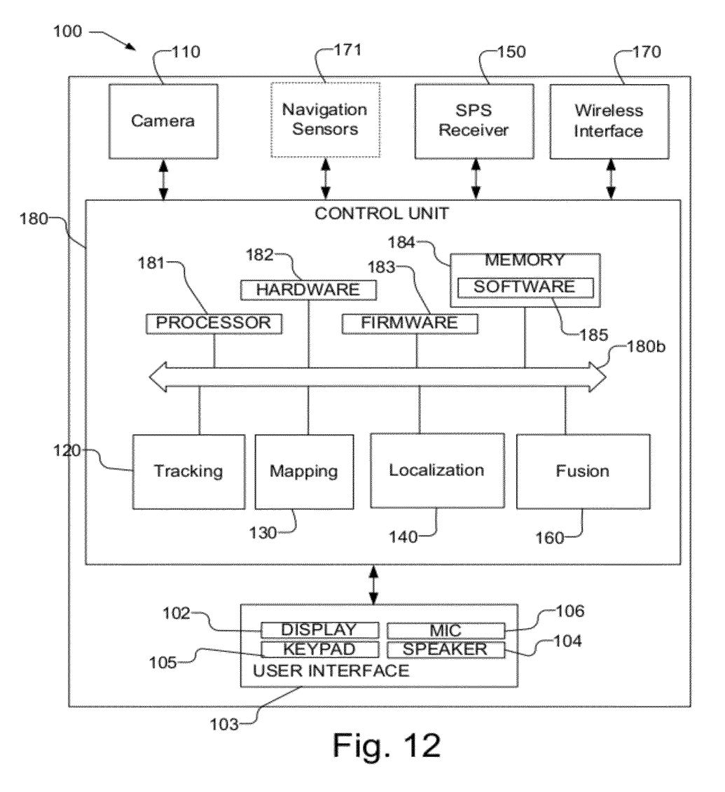

FIG. 12 is a block diagram of a mobile device 100 capable of using panoramic images for real-time localization as discussed above. The mobile device 100 includes a camera 110 and an SPS receiver 150 for receiving navigation signals. The mobile device 100 further includes a wireless interface 170 for receiving wireless signals from network 142 (shown in FIG. 2). The wireless interface 170 may use various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. Moreover, any combination of WWAN, WLAN and/or WPAN may be used.

The mobile device 100 may optionally include non-visual navigation sensors 171, such motion or position sensors, e.g., accelerometers, gyroscopes, electronic compass, or other similar motion sensing elements. The use of navigation sensors 171 may assist in multiple actions of the methods described above. For example, compass information may be used for a guided matching process in which features to be matched as pre-filtered based on the current viewing direction, as determined by the compass information, and visibility constraints. Additionally, accelerometers may be used, e.g., to assist in the panoramic map generation by compensating for non-rotation motion of the camera 110 during the panoramic map generation or warning the user of non-rotational movement.

The mobile device 100 may further includes a user interface 103 that includes a display 102, a keypad 105 or other input device through which the user can input information into the mobile device 100. If desired, the keypad 105 may be obviated by integrating a virtual keypad into the display 102 with a touch sensor. The user interface 103 may also include a microphone 106 and speaker 104, e.g., if the mobile device 100 is a mobile device such as a cellular telephone. Of course, mobile device 100 may include other elements unrelated to the present disclosure.

The mobile device 100 also includes a control unit 180 that is connected to and communicates with the camera 110, SPS receiver, the wireless interface 170 and navigation sensors 171, if included. The control unit 180 may be provided by a bus 180b, processor 181 and associated memory 184, hardware 182, software 185, and firmware 183. The control unit 180 includes a tracking unit 120, mapping unit 130, localization unit 140, and fusion unit 160 that operate as discussed above. The tracking unit 120, mapping unit 130, localization unit 140, and fusion unit 160 are illustrated separately and separate from processor 181 for clarity, but may be a single unit, combined units and/or implemented in the processor 181 based on instructions in the software 185 which is run in the processor 181. It will be understood as used herein that the processor 181, as well as one or more of the tracking unit 120, mapping unit 130, localization unit 140, and fusion unit 160 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile device, and is not to be limited to any particular type of memory or number of memories, or type of media upon which memory is stored.

The mobile device includes means for producing at least a portion of a panoramic cylindrical map of an environment with a camera, which may be, e.g., the camera 110, and may include the mapping unit 130. A means for extracting features from the at least the portion of the panoramic cylindrical map, may be, e.g., the mapping unit 130. A means for comparing the features from the at least the portion of the panoramic cylindrical map to features from a pre-generated three-dimensional model of the environment to produce a set of corresponding features may be, e.g., the localization unit 140. A means for using the set of corresponding features to determine a position and an orientation of the camera may be, e.g., the localization unit and/or the fusion unit 160. The mobile device may include means for converting the set of corresponding features into a plurality of rays, each ray extends between a single two-dimensional feature from the panoramic cylindrical map and a single three-dimensional feature from the pre-generated three-dimensional model, means for determining an intersection of the plurality of rays, and means for using the intersection of the plurality of rays to determine the position and the orientation of the camera, which may be, e.g., the localization unit. The mobile device may include means for capturing a plurality of camera images from the camera as the camera rotates, which may be, e.g., the processor 181 coupled to the camera 110. A means for using the plurality of camera images to generate the at least the portion of the panoramic cylindrical map may be, e.g., the mapping unit 130. The mobile device may include a means means for comparing the features from each tile of the panoramic cylindrical map to the model features from the pre-generated three-dimensional model of the environment when each tile is filled using the plurality of camera images, which may be, e.g., the mapping unit 130. The mobile device may include a means for tracking a relative orientation of the camera with respect to the at least the portion of the panoramic cylindrical map, which may be the tracking unit 120. A means for combining the relative orientation of the camera with the position and orientation determined using the set of corresponding features may be the fusion unit 160. The mobile device may include a means for wirelessly receiving the model features from the pre-generated three-dimensional model of the environment from a remote server, which may be the wireless interface 170 and the processor 181. The mobile device may include means for determining a location of the camera in the environment, which may be, e.g., the SPS receiver 150 and/or navigation sensors 171 and/or wireless interface 170. A means for obtaining a data block of the pre-generated three-dimensional model of the environment using the location of the camera in the environment may be, e.g., the wireless interface 170 and the processor 181.

The methodologies described herein may be implemented by various means depending upon the application. For example, these methodologies may be implemented in hardware 182, firmware 163, software 185, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 184 and executed by the processor 181. Memory may be implemented within or external to the processor 181. If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
producing at least a portion of a panoramic cylindrical map of an environment with a camera;
extracting features from the at least the portion of the panoramic cylindrical map;
comparing the features from the at least the portion of the panoramic cylindrical map to model features from a pre-generated three-dimensional model of the environment to produce a set of corresponding features; and
using the set of corresponding features to determine a position and an orientation of the camera.

2. The method of claim 1, wherein using the set of corresponding features to determine the position and the orientation of the camera comprises:
converting the set of corresponding features into a plurality of rays, each ray extends between a single two-dimensional feature from the panoramic cylindrical map and a single three-dimensional feature from the pre-generated three-dimensional model;
determining an intersection of the plurality of rays; and
using the intersection of the plurality of rays to determine the position and the orientation of the camera.

3. The method of claim 1, wherein producing the at least the portion of the panoramic cylindrical map comprises:
capturing a plurality of camera images from the camera as the camera rotates; and
using the plurality of camera images to generate the at least the portion of the panoramic cylindrical map.

4. The method of claim 3, wherein the at least the portion of the panoramic cylindrical map is subdivided into a plurality of tiles, wherein comparing the features from the at least the portion of the panoramic cylindrical map to the model features from the pre-generated three-dimensional model of the environment comprises comparing the features from each tile in the plurality of tiles to the model features from the pre-generated three-dimensional model of the environment when each tile is filled using the plurality of camera images.

5. The method of claim 1, further comprising:
tracking a relative orientation of the camera with respect to the at least the portion of the panoramic cylindrical map; and
combining the relative orientation of the camera with the position and the orientation determined using the set of corresponding features.

6. The method of claim 1, further comprising wirelessly receiving the model features from the pre-generated three-dimensional model of the environment from a remote server.

7. The method of claim 1, wherein the pre-generated three-dimensional model of the environment is partitioned into data blocks based on visibility and the data blocks are associated with locations in the environment, the method further comprising:
determining a location of the camera in the environment; and
obtaining a data block of the pre-generated three-dimensional model of the environment using the location of the camera in the environment, wherein the features from the at least the portion of the panoramic cylindrical map are compared to the features from the data block of the pre-generated three-dimensional model of the environment.

8. An apparatus comprising:
a camera capable of capturing images of an environment; and
a processor coupled to the camera, the processor configured to produce at least a portion of a panoramic cylindrical map of the environment using images captured by the camera, extract features from the at least the portion of the panoramic cylindrical map, compare the features from the at least the portion of the panoramic cylindrical map to features from a pre-generated three-dimensional model of the environment to produce a set of corresponding features, and use the set of corresponding features to determine a position and an orientation of the camera.

9. The apparatus of claim 8, wherein the processor is configured to use the set of corresponding features to determine the position and the orientation of the camera by being configured to:
convert the set of corresponding features into a plurality of rays, each ray extends between a single two-dimensional feature from the panoramic cylindrical map and a single three-dimensional feature from the pre-generated three-dimensional model;
determine an intersection of the plurality of rays; and
use the intersection of the plurality of rays to determine the position and the orientation of the camera.

10. The apparatus of claim 8, wherein the processor is configured to produce the at least the portion of the panoramic cylindrical map by being configured use a plurality of images captured by the camera as the camera rotates to generate the at least the portion of the panoramic cylindrical map.

11. The apparatus of claim 10, wherein the at least the portion of the panoramic cylindrical map is subdivided into a plurality of tiles, wherein the processor is configured to compare the features from the at least the portion of the panoramic cylindrical map to the model features from the pre-generated three-dimensional model of the environment by being configured to compare the features from each tile in the plurality of tiles to the model features from the pre-generated three-dimensional model of the environment when each tile is filled using the plurality of images.

12. The apparatus of claim 8, the processor being further configured to track a relative orientation of the camera with respect to the at least the portion of the panoramic cylindrical map, and combine the relative orientation of the camera with the position and the orientation determined using the set of corresponding features.

13. The apparatus of claim 8, further comprising a wireless interface coupled to the processor, wherein the processor is further configured to receive the model features from the pre-generated three-dimensional model of the environment from a remote server through the wireless interface.

14. The apparatus of claim 8, further comprising a wireless interface coupled to the processor and a satellite positioning system receiver coupled to the processor, wherein the pre-generated three-dimensional model of the environment is partitioned into data blocks based on visibility and the data blocks are associated with locations in the environment, the processor being further configured to determine a location of the camera in the environment using signals received by the satellite positioning system receiver, receiving through the wireless interface a data block of the pre-generated three-dimensional model of the environment using the location of the camera in the environment, wherein the processor is configured to compare the features from the at least the portion of the panoramic cylindrical map to the features from the data block of the pre-generated three-dimensional model of the environment.

15. An apparatus comprising:
means for producing at least a portion of a panoramic cylindrical map of an environment with a camera;
means for extracting features from the at least the portion of the panoramic cylindrical map;
means for comparing the features from the at least the portion of the panoramic cylindrical map to features from a pre-generated three-dimensional model of the environment to produce a set of corresponding features; and
means for using the set of corresponding features to determine a position and an orientation of the camera.

16. The apparatus of claim 15, wherein the means for using the set of corresponding features to determine the position and the orientation of the camera comprises:
means for converting the set of corresponding features into a plurality of rays, each ray extends between a single two-dimensional feature from the panoramic cylindrical map and a single three-dimensional feature from the pre-generated three-dimensional model;
means for determining an intersection of the plurality of rays; and
means for using the intersection of the plurality of rays to determine the position and the orientation of the camera.

17. The apparatus of claim 15, wherein the means for producing the at least the portion of the panoramic cylindrical map comprises:
means for capturing a plurality of camera images from the camera as the camera rotates; and
means for using the plurality of camera images to generate the at least the portion of the panoramic cylindrical map.

18. The apparatus of claim 17, wherein the at least the portion of the panoramic cylindrical map is subdivided into a plurality of tiles, wherein the means for comparing the features from the at least the portion of the panoramic cylindrical map to the model features from the pre-generated three-dimensional model of the environment comprises means for comparing the features from each tile in the plurality of tiles to the model features from the pre-generated three-dimensional model of the environment when each tile is filled using the plurality of camera images.

19. The apparatus of claim 15, further comprising:
means for tracking a relative orientation of the camera with respect to the at least the portion of the panoramic cylindrical map; and
means for combining the relative orientation of the camera with the position and the orientation determined using the set of corresponding features.

20. The apparatus of claim 15, further comprising means for wirelessly receiving the model features from the pre-generated three-dimensional model of the environment from a remote server.

21. The apparatus of claim 15, wherein the pre-generated three-dimensional model of the environment is partitioned into data blocks based on visibility and the data blocks are associated with locations in the environment, the apparatus further comprising:
means for determining a location of the camera in the environment; and
means for obtaining a data block of the pre-generated three-dimensional model of the environment using the location of the camera in the environment, wherein the features from the at least the portion of the panoramic cylindrical map are compared to the features from the data block of the pre-generated three-dimensional model of the environment.

22. A non-transitory computer-readable medium including program code stored thereon, comprising:
program code to produce at least a portion of a panoramic cylindrical map of an environment with images captured by a camera;
program code to extract features from the at least the portion of the panoramic cylindrical map;
program code to compare the features from the at least the portion of the panoramic cylindrical map to features from a pre-generated three-dimensional model of the environment to produce a set of corresponding features; and
program code to use the set of corresponding features to determine a position and an orientation of the camera.

23. The non-transitory computer-readable medium of claim 22, wherein the program code to use the set of corresponding features to determine the position and the orientation of the camera comprises:
program code to convert the set of corresponding features into a plurality of rays, each ray extends between a single two-dimensional feature from the panoramic cylindrical map and a single three-dimensional feature from the pre-generated three-dimensional model;
program code to determine an intersection of the plurality of rays; and
program code to use the intersection of the plurality of rays to determine the position and the orientation of the camera.

24. The non-transitory computer-readable medium of claim 22, wherein the program code to produce the at least the portion of the panoramic cylindrical map comprises program code to use a plurality of images captured by the camera as the camera rotates to generate the at least the portion of the panoramic cylindrical map.

25. The non-transitory computer-readable medium of claim 24, wherein the at least the portion of the panoramic cylindrical map is subdivided into a plurality of tiles, wherein the program code to compare the features from the at least the portion of the panoramic cylindrical map to the model features from the pre-generated three-dimensional model of the environment comprises program code to compare the features from each tile in the plurality of tiles to the model features from the pre-generated three-dimensional model of the environment when each tile is filled using the plurality of images.

26. The non-transitory computer-readable medium of claim 22, further comprising:
program code to track a relative orientation of the camera with respect to the at least the portion of the panoramic cylindrical map; and
program code to combine the relative orientation of the camera with the position and the orientation determined using the set of corresponding features.

27. The non-transitory computer-readable medium of claim 22, further comprising program code to wirelessly receive the model features from the pre-generated three-dimensional model of the environment from a remote server.

28. The non-transitory computer-readable medium of claim 22, wherein the pre-generated three-dimensional model of the environment is partitioned into data blocks based on visibility and the data blocks are associated with locations in the environment, the non-transitory computer-readable medium further comprising:
program code to determine a location of the camera in the environment; and
program code to obtaining a data block of the pre-generated three-dimensional model of the environment using the location of the camera in the environment, wherein the features from the at least the portion of the panoramic cylindrical map are compared to the features from the data block of the pre-generated three-dimensional model of the environment.
